(19) United States
(12) Patent Application Publication
(10) Pub. No.: US 2025/0005550 A1
(43) Pub. Date: Jan. 2, 2025

(54) IMAGE-BASED SELF-CHECKOUT SHRINK REDUCTION

(71) Applicant: NCR Corporation, Atlanta, GA (US)

(72) Inventors: Mohamad Eydani Asl, Atlanta, GA (US); Matthew K. Farrow, Canton, MA (US)

(21) Appl. No.: 18/217,413

(22) Filed: Jun. 30, 2023

(51) Int. Cl. G06Q 20/20; G06Q 20/18; G06T 5/40; G06V 10/44; G06V 10/74

(52) U.S. Cl. CPC G06Q 20/208; G06Q 20/18; G06T 5/40; G06V 10/44; G06V 10/761

(57) ABSTRACT

Feature vectors derived from images of items are retained in a storage bank and indexed by price lookup (PLU) code. An image of an item and a corresponding entered PLU code during a transaction at a terminal are provided as input to a machine learning model and a current feature vector for the image is provided as output. Model feature vector(s) corresponding to the entered PLU code are obtained from the storage bank. The current feature vector and the model feature vectors are provided as input to a comparison machine learning model, which provides as output a confidence value indicative of a degree of similarity between the feature vectors. When the confidence value fails to meet a confidence threshold, this indicates a low confidence that the item is associated with the entered PLU code and an interrupt is sent to the terminal as an indication of potential shrinkage for the transaction.

### BACKGROUND

Theft is a substantial problem with customer self-checkouts. Theft at self-checkouts can occur in many manners. For example, a customer may indicate an item is a particular produce item by performing a price lookup (PLU) and entering a produce item code into the self-checkout's interface when in fact the item is associated with a higher priced produce item or even a higher priced non-produce item.

Often image-based verification techniques are focused on fine-grain issues such as item recognition derived from an image of an item rather than verification of whether the item is or is not what was entered by the customer at the checkout. As a result, response times for item recognition can be unacceptable for self-checkouts. Additionally, item recognition requires a substantial amount of training images for each item that is recognized before it can be realistically deployed at a self-checkout. Item recognition also requires continuous maintenance and retraining after deployment to maintain acceptable accuracy metrics.

### SUMMARY

In various embodiments, a system and methods for image-based self-checkout shrink reduction are presented. One or more machine learning models (“models”) are trained on produce item images and price lookup (PLU) codes for produce items to generate feature vectors from the images. Each feature vector includes a plurality of features detected by the corresponding model from the corresponding image and linked to the corresponding PLU code. The feature vectors are stored in a reference bank and pre-loaded/pre-cached into memory. During a transaction, an image is captured of an item on a produce scale of a terminal. An operator of the terminal enters a PLU code for the item. The PLU code and the image are provided to a model, which outputs a current feature vector derived from the image. One or more model feature vectors linked to the entered PLU code are obtained from cache or other data storage using the entered PLU code. The obtained feature vectors linked to the PLU code and the current feature vector are provided to another model, which outputs a confidence value indicative of the degree of similarity between the current feature vector and the retrieved feature vector(s). If the confidence value fails to meet a confidence threshold, it is determined t that the item may not be associated with the entered PLU code, and an interrupt is sent to the terminal to verify whether the item is in fact associated with the entered PLU code for purposes of reducing shrinkage or theft during a self-checkout at the terminal.

### BRIEF DESCRIPTION OF THE DRAWINGS

FIG. 1A is a diagram of a system for image-based self-checkout shrink reduction, according to an example embodiment.

FIG. 1B is a flow diagram of a method for image-based self-checkout shrink reduction, according to an example embodiment.

FIG. 2 is a flow diagram of another method for image-based self-checkout shrink reduction, according to an example embodiment.

FIG. 3 is a flow diagram of still another method for image-based self-checkout shrink reduction, according to an example embodiment.

### DETAILED DESCRIPTION

Self-checkouts rely on customers accurately and honestly identifying the produce they purchase. Frequently, produce items lack barcodes such that the customers are asked to search for their produce item's price lookup (PLU) code and select or otherwise enter the corresponding PLU code during the transaction. Fine-grain item recognition is often difficult particularly for different types of produce such as organic versus non organic produce. Item recognition also requires a substantial amount of machine learning model (hereinafter “model” and/or “MLM”) training and maintenance. The response times required by an image recognition model to resolve an item code from one or more images of an item can be such that the benefit of fine-grain item recognition is outweighed by simply relying on the the customer to provide the correct PLU code. Consequently, many retailers still rely on the entered PLU codes provided by their customers, and as a result, are experiencing more shrinkage.

The aforementioned technical problems associated with produce-related shrinkage are are mitigated or eliminated by the technical solution(s) disclosed herein and below. One or more models are trained to produce feature vectors for images of produce with known PLU codes. The feature vectors are stored in a reference bank and preloaded into cache and indexed by PLU code. When a produce item is placed on a scale of a terminal during a transaction, an image of the item and an operator-provided PLU code are provided as input to a model, which returns as output a current feature vector for the item.

The entered PLU code is used to obtain the corresponding model feature vectors from cache. The model feature vectors and the current feature vector are provided to another model, which returns as output a confidence value indicative of the extent of similarity between the current feature vector and the model feature vectors associated with the PLU code. The confidence value is compared to a threshold value and a determination is made as to whether the item is or is not to be associated with the entered PLU code. When the confidence value fails to meet the threshold value, thereby indicating a less than threshold confidence that the item is is associated with the entered PLU code, an interrupt is sent to the terminal to process an exception workflow that at least asks the operator to confirm that PLU code entered is correct. In an embodiment, an audit is performed at the terminal when the operator confirms the entered PLU code is correct.

The techniques presented herein reduce response times and increase processor throughput by performing a memory-efficient coarse grain verification using pre-cached model feature vectors linked to an operator-provided PLU code, which are compared against a current feature vector for a given image of an item. Comparison results are nearly instantaneous and whether the operator has accurately or honestly identified the produce becomes irrelevant. The techniques offer retailers a cost-efficient and highly accurate solution as an alternative to processor/memory/maintenance intensive fine-grain item recognition approaches.

As used herein a “CPG” includes any item that is not a produce item. Thus for purposes of the discussion that follows, a CPG can include a deli item, a bakery item, a dairy item, consumable beverages, consumer packaged foods, non-food items, medications, plants, flowers, etc. As used herein, a “produce item” includes fruits, vegetables, mushrooms, nuts, herbs, any other farm produced item, and any item where barcodes are not commonly used or are sold by weight (e.g., candy, processed cereals, coffee ground by the customer in the store, etc.).

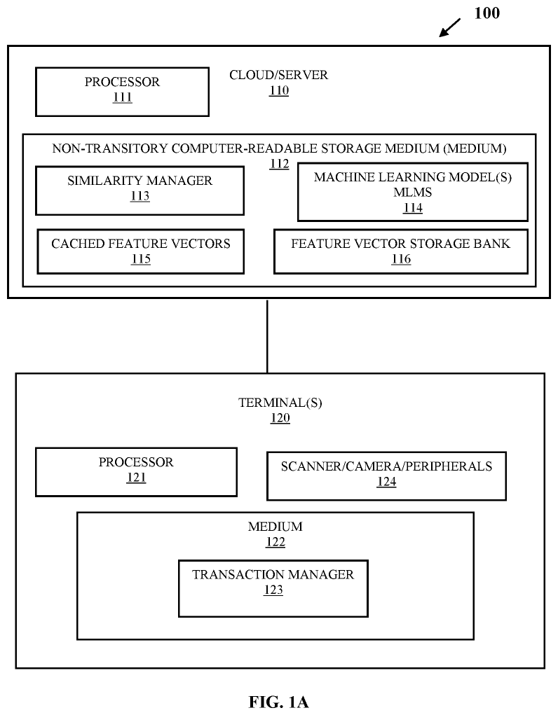

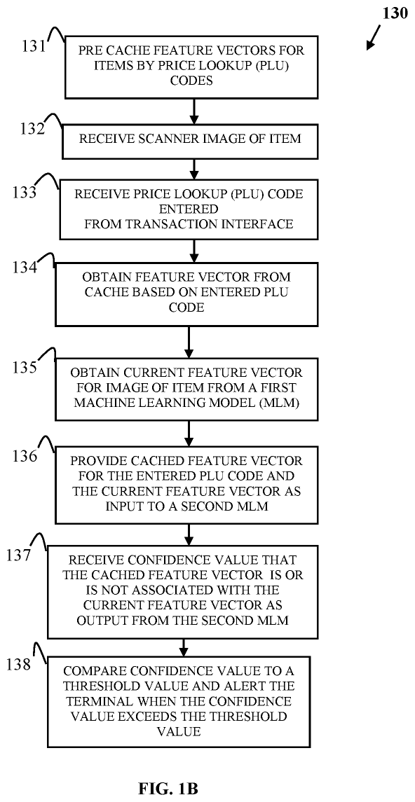

Within this initial context, various embodiments are now presented with reference to FIGS. 1A and 1B. FIG. 1A is a diagram of a system 100 for image-based self-checkout shrink reduction, according to an example embodiment. It is to be noted that the components are shown schematically in greatly simplified form, with only those components relevant to understanding of the embodiments being illustrated.

Furthermore, the various components illustrated in FIG. 1A and their arrangement is presented for purposes of illustration only. It is to be noted that other arrangements with more or less components are possible without departing from the teachings of image-based self-checkout shrink reduction as presented herein and below.

The system 100 includes a cloud 110 or a server 110 (herein after just “cloud 110”) and a plurality of terminals 120. Cloud 110 includes a processor 111 and a non-transitory computer-readable storage medium (herein after just “medium”) 112, which includes executable instructions for a similarity manager 113 and one or more models 114. The instructions when executed by processor 111 perform operations discussed herein and below with respect to 113 and 114. Medium 112 also includes cached feature vectors residing in cache memory and a feature vector storage bank 116, which includes feature vectors generated from images of items by price lookup (PLU) codes.

Each terminal 120 includes a processor 121 and medium 112, which includes executable instructions for a transaction manager 123. Each terminal 120 further includes a scanner/camera/peripherals 124 to capture at least one image of an item during a transaction at the corresponding terminal 120. The instructions when executed by processor 121 perform operations discussed herein and below with respect to 123.

Initially, a model 114 is trained on images depicting produce items and corresponding PLU codes to generate feature vectors linked the corresponding PLU codes. In an embodiment, at least two models are trained independently to generate feature vectors from item images and corresponding PLU codes. In an embodiment, the first model 114 is different from the second model 114. For example, the first model 114 is a Siamese network model and the second model 114 is a similarity network model. Each model 114 is trained on a produce item image and its corresponding PLU code to produce a feature vector for the PLU code based on features identified in the corresponding produce item image. For example, at least one item image for a model bunch of bananas and a corresponding PLU code for the bananas are provided as input to each model 114; each model 114 independently produces a model or reference feature vector for the PLU code based on features identified in the banana bunch image. Features include, by way of example only, shape, texture, color, edges, lines, dimensions, etc. Each feature identified in the corresponding vector includes a value on a predefined scale that indicates the degree to which the corresponding feature is present in the model banana bunch image.

Similarity manager 113 stores the model or reference feature vectors by PLU code in feature vector storage bank 116. In an embodiment, a single PLU code includes at least 2 feature vectors, one from the first model 114 and one from the second model 114. In an embodiment, similarity manager 113 maintains two or more feature vectors for each PLU code generated by each model 114. In other words, multiple feature vectors produced by each model 114 is stored in the feature vector storage bank 116 following training. In an embodiment, following training of the model(s) 114, similarity manager 113 averages, performs a pairwise, or other statistically analysis on each model's output feature vectors to derive a single model feature vector for each PLU code.

After training, similarity manager 113 pre loads and pre caches the feature vectors by PLU code in memory from the feature vector storage bank 116. This ensures fast lookup and acquisition of the corresponding feature vectors when a PLU code is received during a transaction at terminal 120. Similarity manager's response times are nearly instantaneous when a similarity or dissimilarity decision is needed on a given item image and entered PLU code during a transaction on terminal 120 because model feature vectors are obtained quickly and directly from an in-memory table using the entered PLU code without accessing feature vector storage bank 116.

During a transaction, an image of an item placed on a produce scale of terminal 120 is captured by scanner/camera 124. Transaction manager 123 receives an entered or selected PLU code for the item from the operator of terminal 120. The PLU code and image are provided to similarity manager 113. The model feature vectors corresponding to the PLU code are obtained from the cached feature vectors 115. The image of the item is provided as input to a model 114 and a current feature vector is returned as output. Similarity manager 113 provides the cached feature vectors corresponding to the PLU code and the current feature vector as input to another model 114, which is trained to take one to a plurality of model feature vectors and compare the feature vectors against a current feature vector to output a confidence value that corresponds to an extent to which the current feature vector is similar or dissimilar to the model feature vector(s). Similarity manager 113 compares the confidence value against a threshold value or range of values and when the confidence value is determined to be dissimilar to the entered PLU code, similarity manager 113 sends an interrupt message to transaction manager 123. Transaction manager 113 requests that the operator confirm that the item is to be associated with the entered PLU code. When the operator confirms, transaction manager 113 is configured to perform an exception workflow that can either accept the confirmation or request an audit of the transaction to verify the item is to be associated with the entered PLU code or not. In an embodiment, the confirmation or the result of the audit causes similarity manager 113 to retain the current feature vector for the item and the entered PLU code as another model feature vector linked to the PLU code in the feature vector storage bank. In this way, training of the comparison model 114 is eliminated as model feature vectors for incorrect dissimilar decisions are updated to include current feature vectors as one of the model feature vectors provided to the comparison model 114.

In an embodiment, comparison model 114 is initially trained on triplets of three feature feature vectors derived from three images per PLU code. A first of the three feature vectors is derived from an image of the item corresponding to the PLU code, which is easy to determine the item. The second of the three feature vectors is derived from an image of the item corresponding to the PLU code, which is difficult to determine the item. The third of the three feature vectors is derived from an image that does not correspond to the PLU code at all. The comparison model 114 is trained to output a confidence value as to whether the third feature vector in any given triplet is or is not similar to the other two feature vectors of the triplet.

In an embodiment, comparison model 114 is initially trained on sets of 4 feature vectors per PLU code. The first feature vector of the set is derived from an image that is the PLU code, the second feature vector of the set is derived from an image that is similar to the PLU code but different, the third feature vector is derived from an image that is associated with the PLU code but is difficult to detect, and the fourth feature vector is derived from an image that is not associated with the PLU code. The comparison model 114 is trained to output a confidence value as to whether the fourth feature vector is or is not similar to the PLU code.

In an embodiment, each time a transaction includes a PLU code and an image of an item, the feature vector for the image is added to the feature vector storage bank 116. The feature vector storage bank 116 drops an oldest model feature vector out of the retained feature vectors replacing the dropped feature vector with the newly added feature vector. A configured number of feature vectors are retained per PLU code. The comparison model 114 uses a variety of techniques to optimally maintain the current set of feature vectors per PLU code to weight, average, use histograms, and/or poll the features from the retained feature vectors when comparing against a current set of features included in a current feature vector and producing a current confidence value for similarity or dissimilarity. In an embodiment, when adding a new feature vector for a given PLU to the feature vector storage bank 116 heuristic rules are employed to determine which of the retained feature vectors should be removed. For example, a frequency counter can be retained for each retained feature vector per PLU, when a new feature vector results in a frequency counter being increased, the lowest feature vector with the current lowest frequency counter is removed. In an embodiment, rather than storing raw model feature vectors, two or more aggregated model feature vectors are retained per PLU code in the feature vector storage bank 116, each of the aggregated model feature vectors are updated based on a newly encountered feature vector for a current transaction associated with a corresponding PLU code. Each of the two or more aggregated feature vectors are computed using averages per feature, a histogram per feature, pairwise calculations per feature, weights per feature, polling per feature, etc.

In an embodiment, the comparison model 114 takes as input the raw image of the item for a given transaction and the model feature vectors corresponding to the entered PLU code. The comparison model generates the current feature vector from the image and compares the current feature vector against the model feature vectors. In this embodiment, there is no need for a model to provide as output the current feature vector as this is done by the comparison model 114. Also, in this embodiment, the comparison model 114 also outputs with the confidence value the current feature vector derived from the image of the item. Similarity manager 113 retains the current feature vector, the entered PLU code, and the image for the item for a determination as to whether the current feature vector is to be added to the feature vector storage bank 116. For example, when the comparison model 114 indicates through an outputted confidence value that the item is dissimilar to the entered PLU code and an audit or confirmation confirms that the item is associated with the entered PLU code, similarity manager 113 can add the outputted current feature vector generated and outputted by the comparison model 114 to the feature vector storage bank 116.

In an embodiment, each time a new feature vector is added to the feature vector storage bank 116 or each time the model feature vectors for a given PLU code are updated or recomputed, the changed feature vectors are updated to the cached feature vectors 115. This ensures that the cached feature vectors 115 remain up to date for each transaction at terminal 120.

In an embodiment, terminal 120 is a self-service terminal, which is operated by a customer during a self-checkout. In an embodiment, terminal 120 is a point-of-sale terminal, which is operated by a cashier during an assisted customer checkout. Thus, system 100 is deployable with assisted customer checkouts to verify the accuracy of cashiers in identifying produce items.

FIG. 1B is a flow diagram of a method 130 for image-based self-checkout shrink reduction, according to an example embodiment. The method is implemented as executable instructions representing the similarity manager 113. The instructions are executed by processor 111 on cloud 110.

At 131, the similarity manager 113 pre caches feature vectors for items by PLU code using feature vector storage bank 116. Each PLU code linked to one or a plurality of feature vectors. In an embodiment, the feature vectors retained per PLU code is a rolling average of previous feature vectors, a histogram of previous feature vectors, pairwise calculates for previous feature vectors, polling calculations of previous feature vectors, etc.

At 132, similarity manager 113 receives a scanner image of an item placed on a produce scale of terminal 120 from transaction manager 123. At 133, similarity manager 113 receives a PLU code entered from a transaction interface of transaction manager 123.

At 134, similarity manager 113 obtains one or more model feature vectors for the PLU code from the cached feature vectors 115. At 135, similarity manager 113 provides the image of the item and the PLU code as input to a first model 114 and obtains as output a current feature vector derived from the image by the first model 114.

At 136, similarity manager 113 provides the one or more cached feature vectors 115 for the entered PLU code and the current feature vectors as input to a second or a comparison model 114. At 137, the similarity manager receives a confidence value that the cached feature vector is or is not associated with the current feature vector as output from the comparison model 114.

At 138, the similarity manager 113 compares the confidence value to a threshold value or a threshold range of values. The similarity manager 113 sends an alert or an interrupt to transaction manager 123 when the confidence value exceeds the threshold value of falls outside the threshold range of values indicating that the item image captured for the item of the transaction corresponding to the current feature vector does not match or is not similar to what is expected for the entered PLU code.

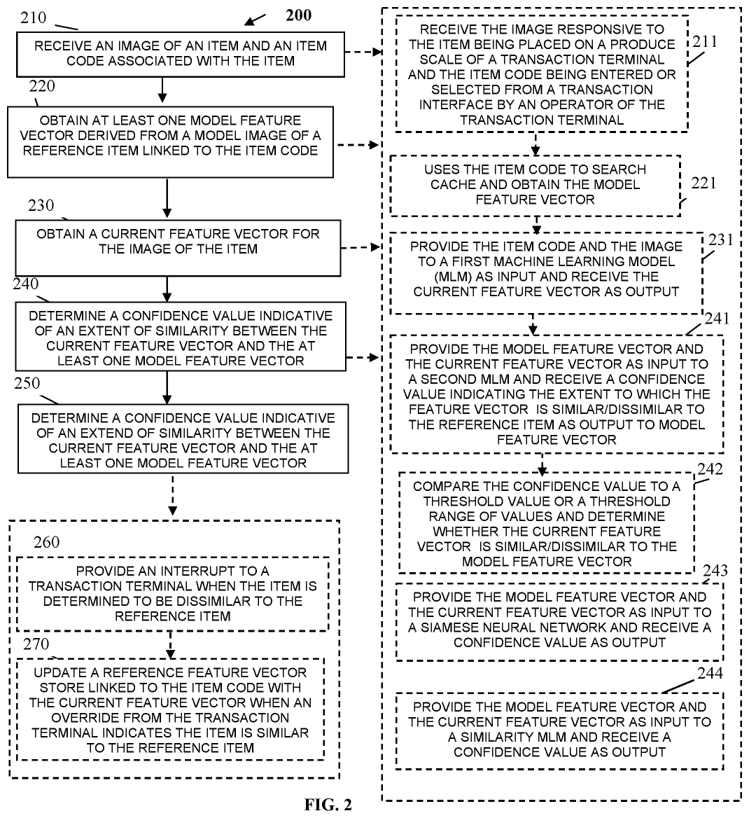

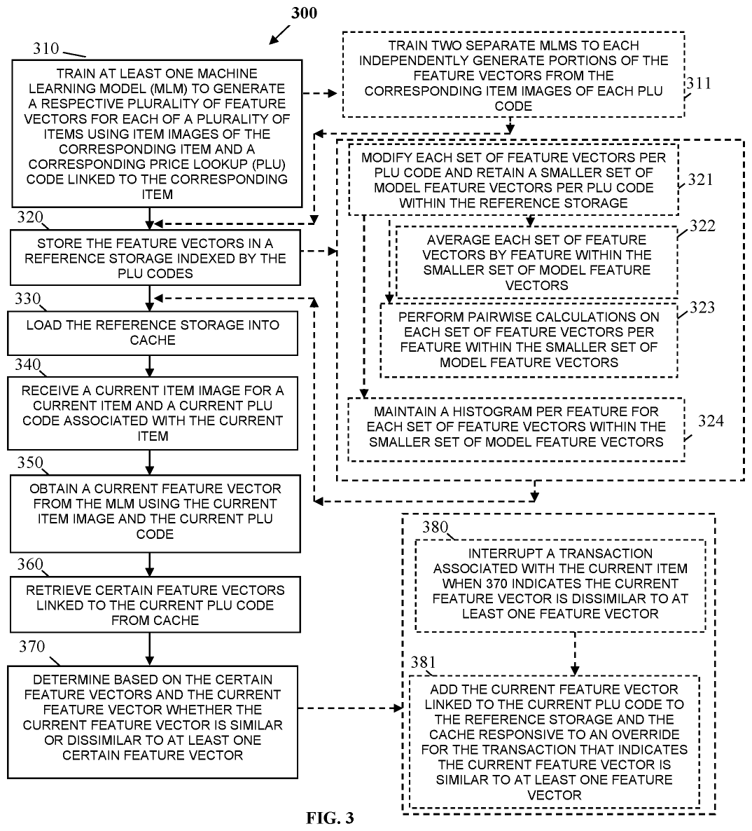

The above-referenced embodiments and other embodiments are now discussed with reference to FIGS. 2 and 3. FIG. 2 is a flow diagram of a method 200 for image-based self-checkout shrink reduction, according to an example embodiment. The software module(s) that implements the method 200 is referred to as an “item verification manager.” The item verification manager is implemented as executable instructions programmed and residing within memory and/or a non-transitory computer-readable (processor-readable) storage medium and executed by one or more processors of one or more devices. The processor(s) of the device(s) that executes the item verification manager are specifically configured and programmed to process the item verification manager. The item verification manager has access to one or more network connections during its processing. The connections can be wired, wireless, or a combination of wired and wireless.

In an embodiment, the device that executes the item verification manager is cloud 110 or server 110. In an embodiment, server 110 is a server of a given retailer that manages multiple stores, each store having a plurality of terminals 120. In an embodiment, terminal 120 is a self-service terminal or a point-of-sale terminal. In an embodiment, the item verification manager is some, all, or any combination of, similarity manager 113, one or more models 114, and/or method 130 of FIG. 1B.

At 210, item verification manager receives an image of an item and an item code associated with the item. In an embodiment, the item code is a PLU code for a produce item.

In an embodiment, at 211, the item verification manager receives the image responsive to the item being placed on a produce scale of a transaction terminal 120 and responsive to the item code being entered into a transaction interface by an operator of the terminal 120. In an embodiment, the operator is a customer performing a self-service transaction at a self-service terminal. In an embodiment, the operator is a cashier performing a cashier-assisted transaction for the customer at a point-of-sale terminal.

At 220, the item verification manager obtains at least one model feature vector that includes features derived from the image. The feature vector is derived from a model image of a reference item that is linked to the item code.

In an embodiment of 211 and 220, at 221, the item verification manager uses the item code to search cache and obtain the feature vector. That is, a cache table is maintained in memory indexed by item code, such that access is direct and nearly instantaneous for purposes of obtaining the feature vector(s).

At 230, the item verification manager obtains a current feature vector for the image of the item. That is, the image and the item code are used for obtaining a current set of features derived from the image.

In an embodiment of 221 and 230, at 231, the item verification manager provides the item code and the image to a first model/MLM 114 as input. Responsive to the input, the item verification manager receives as output the current feature vector from the first model/MLM 114.

At 240, the item verification manager determines whether the item is similar or dissimilar to the reference item based on at least one model feature vector and the current feature vector. That is, the model feature vector or a set of model feature vectors linked to the item code are compared against the current feature vector to determine an extend to which the current feature vector is similar or dissimilar to at least one model feature vector.

In an embodiment of 231 and 240, at 241, the item verification manager provides the feature vector(s) and the current feature vector as input to a second model/MLM 114. Responsive to the input, the item verification manager receives a confidence value that indicates the extend to which the current feature vector is similar or dissimilar to at least one model feature vector.

In an embodiment of 241 and at 242, the item verification manager compares the confidence value to a threshold value or a threshold range of values. Based on the comparison, the item verification manager determines the extend to which the current feature vector is similar or dissimilar to at least one model feature vector.

In an embodiment of 240, at 243, the item verification manager provides the model feature vector(s) and the current feature vector as input to a Siamese neural network 114. Responsive to the input, the item verification manager receives as output the confidence value.

In an embodiment of 240, at 244, the item verification manager provides the feature vector(s) and the current feature vector as input to a similarity model/MLM 114. Responsive to the input, the item verification manager receives as output the confidence value.

In an embodiment, at 250, the item verification manager provides or causes an interrupt on the transaction terminal when the current feature vector is determined at 240 to be dissimilar to the model feature vector(s). Transaction manager 123 can process a custom exception workflow responsive to the interrupt.

In an embodiment of 250 and at 260, the item verification manager updates a reference model feature vector store linked to the item code with the current feature vector when an override from the transaction terminal 120 indicates the current feature vector is similar to the at least one model feature vector. This is an indication that the determination of dissimilarity was incorrect at 240 and the corresponding feature vector for the image of the item is retained as a new model feature vector in the reference model feature vector store to improve an accuracy of the determining at 240 on subsequent iterations of the item verification manager.

FIG. 3 is a flow diagram of a method 300 for image-based self-checkout shrink reduction, according to an example embodiment. The software module(s) that implements the method 300 is referred to as a “produce item verifier.” The produce item verifier is implemented as executable instructions programmed and residing within memory and/or a non-transitory computer-readable (processor-readable) storage medium and executed by one or more processors of one or more devices. The processor(s) of the device(s) that executes the produce item verifier are specifically configured and programmed to process the produce item verifier. The produce item verifier has access to one or more network connections during its processing. The connections can be wired, wireless, or a combination of wired and wireless.

In an embodiment, the device that executes the produce item verifier is cloud 110 or server 110. In an embodiment, server 110 is a server of a given retailer that manages multiple stores, each store having a plurality of terminals 120. In an embodiment, terminal 120 is a self-service terminal or a point-of-sale terminal. In an embodiment, the produce item verifier is some, all, or any combination of, similarity manager 113, one or more models 114, method 130, and/or method 200. In an embodiment, the produce item verifier presents another, and in some ways, an enhanced processing perspective to that which was discussed above with method 130 of FIG. 1B and method 200 of FIG. 2.

At 310, produce item verifier trains at least one model/MLM 114 to generate a respective plurality of feature vectors for each of a plurality of items using item images of the corresponding item and a corresponding PKU code linked to the corresponding item. In an embodiment, at 311, the produce item verifier trains two separate models/MLMs 114 to each independently generate portions of the features vectors from the corresponding item images of each PLU code. That is, each item image for a given PLU code is associated with two separate feature vectors, one generated by a first model/MLM 114 and one generated by a second model/MLM 114.

At 320, the produce item verifier stores the feature vectors in a reference storage 116 indexed by the PLU codes. In an embodiment, at 321, the produce item verifier modifies each set of feature vectors per PLU code and retains a smaller set of model feature vectors per PLU code within the reference storage 116.

In an embodiment of 321 and at 322, the produce item verifier averages each set of feature vectors by feature within the smaller set of model feature vectors. In an embodiment of 321 and at 323, the produce item verifier performs pairwise calculates on each set of feature vectors per feature within the smaller set of model feature vectors. In an embodiment of 321 and at 324, the produce item verifier maintains a histogram per feature for each set of feature vectors within the smaller set of model feature vectors.

At 330, the produce item verifier loads the reference storage 116 into cache. This provides near instantaneous and direct access to the feature vectors of any given PLU code.

At 340, the produce item verifier receives a current item image for a current item and a current PLU code associated with the current item. The current item image and the current PLU code received from transaction manager 123 during a transaction on terminal 120.

At 350, the produce item verifier obtains a current feature vector from the model/MLM 114 using the current item image and the current PLU code. That is, the current item image and the current PLU code is provides as input to the model/MLM 114 and the current feature vector is provided as output from the model/MLM 114.

At 360, the produce item verifier retrieves certain feature vectors linked to the current PLU code from the cache. At 370, the produce item verifier determined based on the certain feature vectors and the current feature vector whether the current feature vector is similar or dissimilar to at least one certain feature vector linked to the current PLU code.

In an embodiment, at 380, the produce item verifier interrupts or causes an interrupt of a transaction associated with the current item when 370 indicates the current feature vector is dissimilar to the certain feature vector(s). In an embodiment of 380 and at 381, the produce item verifier adds the current feature vector linked to the current PLU code to the reference storage 116 and the cache responsive to an override for the transaction that indicates the current feature vector is similar to the certain feature vector(s).

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner. Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
receiving an image of an item and an operator-provided item code associated with the item;
obtaining at least one model feature vector derived from a model image of a reference item linked to the item code;
obtaining a current feature vector for the image of the item;
determining a confidence value indicative of an extent of similarity between the current feature vector and the at least one model feature vector; and
determining whether the item is similar or dissimilar to the reference item based on the confidence value.

2. The method of claim 1 further comprising:
providing an interrupt to a transaction terminal when the item is determined to be dissimilar to the reference item.

3. The method of claim 2 further comprising:
updating a reference feature vector store linked to the item code with the current feature vector when an override from the transaction terminal indicates the item is similar to the reference item.

4. The method of claim 1, wherein receiving further includes receiving the image responsive to the item being placed on a produce scale of a transaction terminal and the item code being entered into or selected from a transaction interface by an operator of the transaction terminal.

5. The method of claim 4, wherein obtaining the at least one model feature vector further includes using the item code to search a cache and obtain the at least one model feature vector.

6. The method of claim 5, wherein obtaining the current feature vector further includes providing the item code and the image to a first machine learning model (MLM) as input and receiving the current feature vector as output from the first MLM.

7. The method of claim 6, wherein determining further includes providing the at least one model feature vector and the current feature vector as input to a second MLM and receiving a confidence value indicating the extent to which the current feature vector is similar or dissimilar to the at least one model feature vector as output from the second MLM.

8. The method of claim 7, wherein providing further includes comparing the confidence value to a threshold value or a threshold range of values and determining whether the current feature vector is similar or dissimilar to the at least one model feature vector.

9. The method of claim 1, wherein determining further includes providing the at least one model feature vector and the current feature vector as input to a Siamese neural network and receiving a confidence value as output, wherein the confidence value is the extent to which the current feature vector is similar or dissimilar to the at least one model feature vector.

10. The method of claim 1, determining further includes providing the at least one feature vector and the current feature vector as input to a similarity machine learning model and receiving a confidence value as output, wherein the confidence value is the extent to which the item is current feature vector is similar or dissimilar to the at least one model feature vector.

11. A method, comprising:
training at least one machine learning model (MLM) to generate a respective plurality of feature vectors for each of a plurality of items using item images of a corresponding item and a corresponding price lookup (PLU) code linked to the corresponding item;
storing the feature vectors in a reference storage indexed by the PLU codes;
loading the reference storage into a cache;
receiving a current item image for a current item and a current PLU code associated with the current item;
obtaining a current feature vector from the at least one MLM using the current item image and the current PLU code;
retrieving certain feature vectors linked to the current PLU code from the cache; and
determining based on the certain feature vectors and the current feature vector whether the certain feature vector is similar or dissimilar to at least one certain feature vector.

12. The method of claim 11 further comprising:
interrupting a transaction associated with the current item when the determining indicates the current feature vector is dissimilar to the at least one certain feature vector.

13. The method of claim 12 further comprising:
adding the current feature vector linked to the current PLU code to the reference storage and the cache responsive to an override for the transaction that indicates the current feature vector is similar to the at least one certain feature vector.

14. The method of claim 11, wherein training further includes training two separate MLMs to each independently produce portions of the feature vectors from the corresponding item images of each PLU code.

15. The method of claim 11, wherein storing further includes modifying each set of feature vectors per PLU code and retaining a smaller set of model feature vectors per PLU code within the reference storage.

16. The method of claim 15, wherein modifying further includes averaging each set of feature vectors by feature within the smaller set of model feature vectors.

17. The method of claim 15, wherein modifying further includes performing pairwise calculations on each set of feature vectors by feature within the smaller set of model feature vectors.

18. The method of claim 15, wherein modifying further include maintaining a histogram per feature for each set of feature vectors within the smaller set of model feature vectors.

19. A system, comprising:
at least one server comprising at least one processor and a non-transitory computer-readable storage medium;
the non-transitory computer-readable storage medium comprising executable instructions; and
the executable instructions when executed by at least one processor cause the at least one processor to perform operations, comprising:
receiving an item image for an item placed on a scale of a terminal during a transaction;
receiving an item code entered for the item at the terminal;
obtaining feature vectors from a cache based on the item code, wherein the feature vectors derived from other item images associated with a reference item linked to the item code;
obtaining a current feature vector for the item using the item image;
determining whether the current feature vector is similar to dissimilar to the feature vectors based on comparing the feature vectors against the current feature vector; and
interrupting the transaction on the terminal when the determining indicates the item is dissimilar to the reference item.

20. The system of claim 19, wherein the terminal is a self-service terminal operated by a customer during the transaction or the terminal is a point-of-sale terminal operated by a cashier for the customer during the transaction.
